(19) United States
(12) Patent Application Publication
(10) Pub. No.: US 2017/0083102 A1
(43) Pub. Date: Mar. 23, 2017

(54) GESTURE RECOGNITION DATA TRANSFER

(71) Applicant: International Business Machines Corporation, Armonk, NY (US)

(72) Inventors: Eli M. Dow, Wappingers Falls, NY (US); Thomas D. Fitzsimmons, POUGHKEEPSIE, NY (US); Tynan J. Garrett, POUGHKEEPSIE, NY (US); Emily M. Metruck, POUGHKEEPSIE, NY (US)

(21) Appl. No.: 14/931,951

(22) Filed: Nov. 4, 2015

Related U.S. Application Data
(63) Continuation of application No. 14/856,741, filed on Sep. 17, 2015.

(51) Int. Cl. G06F 3/01; H04L 29/08; G06Q 10/10; G06F 1/16

(52) U.S. Cl. CPC G06F 3/017; G06F 1/163; H04L 67/06; H04L 67/10; G06Q 10/10

(57) ABSTRACT

Embodiments of the present invention provide a method and system for sharing content between devices, where one of the devices is a wearable device. The wearable device is configured to detect a second device, detect movement and send a data file wirelessly to the second device. Initially, a set of movement data and an associated data file is stored in the wearable device. The movement data may be a gesture such as a handshake, a high-five or a fist bump. Once the wearable device receives at least one movement, it determines whether the movement is similar to the set of stored movements. If, the received movement of the wearable device is similar to the stored movements, the wearable device sends the associated data file to the second device. Based on the determined gesture, the wearable device may send different files.

### BACKGROUND OF THE INVENTION

The present invention relates generally to the field of mobile computing and, in particular, utilizing hand gestures on a wearable computing device to initiate a data transfer.

Advances in electronic technology allow for near instantaneous communication and data exchange, while leading to ever smaller devices. Recent advances in sensor technology, as well as the miniaturization of both electronics and power sources allow for the scaling down of commonly used devices. Specifically, computing devices have benefited from recent advancements in microprocessor design, providing increasingly complex computations while providing successively diminutive size.

Mobile computing devices provide a user with access to computing capabilities even as the user moves about to various locations. Many people carry one or more computing devices with them throughout their daily activities, for example, to keep in contact with others, to provide information, used as entertainment, etc. Wearable technological computing devices includes non-intrusive devices a user may wear on their body without impeding daily activities. Common wearable devices may include a watch, bracelet or other wrist worn device. Such devices may work independently, or sync to another electronic device such as a mobile phone.

### SUMMARY

According to one embodiment of the present invention, a method for sharing content between devices is provided, the method comprising: storing, by one or more processors, a first gesture, wherein the stored first gesture comprises movement data and an associated first data file; discovering, by a first device, a second device, wherein the first device is configured to detect movement and send the associated first data file wirelessly to the second device and wherein the first device is a wearable device; receiving, by one or more processors, at least one movement of the first device; determining, by one or more processors, that the received at least one movement of the first device is similar to the stored first gesture; and in response to determining the received at least one movement of the first device is similar to the stored first gesture, sending the associated first data file from the first device to the second device.

Another embodiment of the present invention provides a computer program product for sharing content between devices, based on the method described above.

Another embodiment of the present invention provides a computer system for sharing content between devices, based on the method described above.

### BRIEF DESCRIPTION OF THE DRAWINGS

FIG. 1 is a functional block diagram illustrating a user interface environment, in accordance with an embodiment of the present invention;

FIG. 2 is a flowchart illustrating operational steps for a gesture initiated file transfer program, executed on a wearable device, in accordance with an embodiment of the present invention; and

FIG. 3 is a block diagram of internal and external components of the computer systems of FIG. 1, in accordance with an embodiment of the present invention.

### DETAILED DESCRIPTION

Mobile devices have become an essential part of daily life. The small size of computing devices allows them to be easily portable and even wearable. Wearable devices, are unobtrusive for the wearer, as they are small and light weight.

Wearable devices may be provided in various form factors and may be designed to be worn in a variety of ways. In some embodiments of the present invention, a wearable device is a smart watch. A smart watch is a computerized wristwatch with functionality that is enhanced beyond mere time keeping; rather a smart watch is essentially a wearable computer. Many smart watches can run applications, while others contain additional capabilities, for example, making and receiving phone calls, replacing a traditional smart phone. In other embodiments of the present invention, a wearable device is a wrist band, where a wrist band is a secondary device, connected wirelessly or wired to a primary computing device. Embodiments of the present invention provide systems and methods for detecting specific gestures and transmitting data corresponding to the detected gesture to nearby devices.

It is to be understood that while the concepts included herein are presented in the context of a wearable device, in particular a smart watch, these concepts may be applied in other contexts as well if the appropriate hardware is available. For example, many modern smartphones include motion sensors, such as accelerometers and gyroscopes, enabling the concepts discussed herein, if appropriate, to be implemented in such a device.

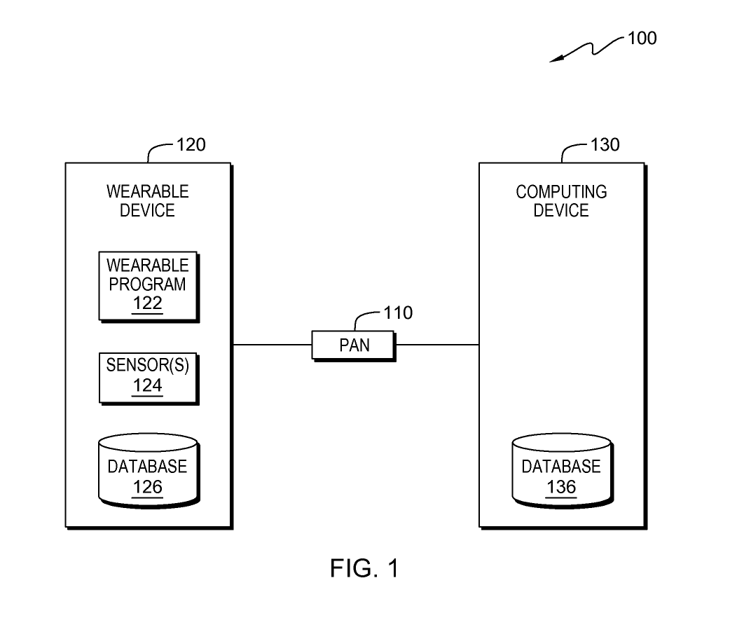

The present invention will now be described in detail with reference to the Figures. FIG. 1 is a functional block diagram depicting a user interface environment, generally designated 100, in accordance with one embodiment of the present invention. FIG. 1 provides only an illustration of one embodiment and does not imply any limitations with regard to the environments in which different embodiments may be implemented. Many modifications to the depicted environment may be made by those skilled in the art without departing from the scope of the invention, as recited by the claims. In this exemplary embodiment, user interface environment 100 includes wearable device 120 and computing device 130, connected over Personal Area Network (PAN) 110.

PAN 110 may be a computer network with a small geographic scope. Computer networks with a small geographic scope range from NFC to Local Area Networks (LANs). A computer network with a small geographic scope typically does not have a connection to the Internet or other remote networks. In an alternative embodiment, PAN 110 is not intended to be limited to a small geographic scope, rather PAN 110 may include a larger networking environment. For example, PAN 110 may be used for communication among mobile devices themselves (intrapersonal communication) or for connecting to a higher level network (e.g., the Internet). A wireless personal area network (WPAN) is a PAN carried over wireless network technologies such as BLUETOOTH® or peer-to-peer communications over a wireless LAN (Bluetooth is a registered trademark of Bluetooth SIG, Inc.). PAN 110 architecture may include one or more information distribution network(s), of any type(s) such as for example, cable, fiber, satellite, telephone, cellular, wireless, etc., and as such, may be configured to have one or more communication channels. In another embodiment PAN 110 may represents a “cloud” of computers interconnected by one or more networks, where PAN 110 is a computing system utilizing clustered computers and components to act as a single pool of seamless resources when accessed.

The various aspects of PAN 110 are not limited to radio frequency wireless communications; rather, communication may be accomplished via any known mediums in the art, including but not limited to, acoustic mediums, and optical mediums, such as, visible or infrared light or ultrasound. For example, data exchanged between devices, may be transmitted via infrared data links using well known technologies, such as infrared transceivers included in some mobile device models.

In embodiments of the present invention, wearable device 120 and computing device 130 each have the necessary hardware to allow for communication over any preconfigured type of PAN 110 used to send, receive and/or control data between them (e.g., a Bluetooth radio). In an alternative embodiment, wearable device 120 and computing device 130 may communicate via a third device, for example a smart phone, which may be included in PAN 110. PAN 110 may be any combination of connections and protocols that support communications between wearable device 120 and computing device 130, in accordance with an embodiment of the present invention.

In the various embodiments of the present invention, wearable device 120 and computing device 130 represent wearable devices. For example, wearable device 120 and computing device 130 both might be smart watches, capable of detecting gestures and transmitting data. Alternatively, wearable device 120 and computing device 130 both might be smart watches, paired with a smart phone, wherein wearable device 120 detects a gesture and its paired smart phone transmits the data to computing device 130 or to computing device 130 paired smart phone.

In the various embodiments of the present invention, wearable device 120 and computing device 130 represent computing devices. Wearable device 120 and computing device 130 may be multi-purpose devices that, for example, include a telephone, or digital music player, a fitness tracker, a ring, etc. Generally, wearable device 120 is wearable and able to detect gestures. Additionally, computing device 130 may be a wearable device and able to detect gestures. Alternatively, computing device 130 may not be a wearable device, but able to receive and/or share information between itself and wearable device 120.

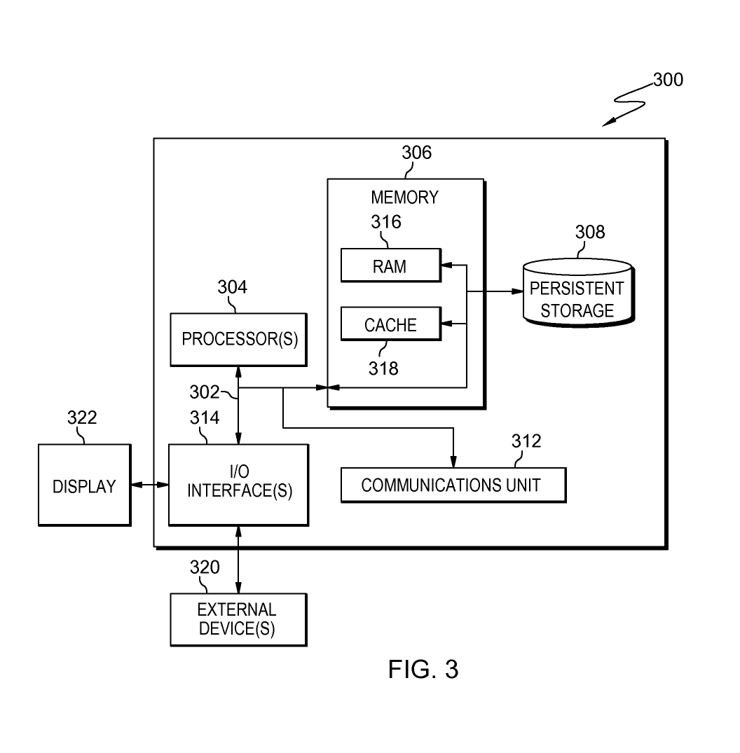

Wearable device 120 and computing device 130 may include internal and external hardware components, as depicted and described in further detail with respect to FIG. 3.

In an exemplary embodiment, wearable device 120 is a device worn by a user. Wearable device 120 includes wearable program 122, sensors(s) 124 and a database 126. Examples of wearable device 120 include, but are not limited to, a ring, a bracelet, a wristband or a wristwatch.

In some embodiments, wearable devices may leverage other devices external to the wearable device, such as a mobile phone or a personal computer. The concepts disclosed and discussed herein, may be applied to both, a standalone wearable device, as well as a wearable device that leverages functionalities provided in external devices, e.g., smartphones, wireless headphones, etc.

Wearable program 122, analyzes data from sensor(s) 124 and database 126 to allow wearable device 120 to interact intelligently to specific user gestures. Utilizing at least one sensor(s) 124, wearable program 122 detects various gestures which correlate to specific predetermined functions. For instance, wearable program 122 allows a user to be cognitively and physically involved with sharing specific data, by linking the act of transferring a specific file type or a specific file (or set of files) of certain data to predetermined gestures that have intuitive meaning to the user.

Through various components, wearable program 122 may detect computing device 130. Additionally, wearable program 122, through an input of sensor(s) 124, may commence a predetermined file transfer. For example, when sensor(s) 124 detects a gesture, wearable program 122 may identify the gesture being performed and execute the predetermined function associated with the identified gesture. In some embodiments, wearable program 122 receives the orientation and movements of wearable device 120 from the orientation sensors. As such, wearable program 122 may determine if a given orientation and movement, or gesture, is detected. For example, various predetermined gestures may include, but not limited to, a hand shake, a fist bump or a ‘high-five’. Any gesture may be established as a predetermined gesture, and associated with a specific file transfer. Upon an indication from sensor 124, wearable program 122, derives the type of gesture the user of wearable device 120 made.

Sensor(s) 124 sense, detects and/or measures various movements and gestures of the user of wearable device 120. Typically a gesture is the movement of the position of one's hand, arm, body, head or face used as a means of expression. Sensor(s) 124 may determine specific user gestures. Exemplary gestures may include but not limited to, tilting, shaking, tapping, and specific directional moving, as well as complex variations of the above. In an exemplary embodiment wearable program 122 determines if the various gestures detected by sensor(s) 124 are predetermined gestures. Additionally, sensor(s) 124 may also detect orientation and movements of wearable device 120.

One of ordinary skill in the art will appreciate that any arrangement of input sensors may be included on wearable device 120 to receive commands from a user. Sensors 124 for the wearable device 120 may include, but are not limited to, accelerometers, gyroscope, thermometer, altimeter, barometer, compass, location determining device (e.g., GPS), proximity sensors, motion detectors, touch sensors, or the like. As one skilled in the art may see, any sensor or sensor combination in wearable device 120 may be used without deviating from the invention, as sensor(s) 124 permit user to interact with wearable device 120.

Sensor(s) 124 may detect movements as a function of time. A gesture may be made up of varying positions expressed as a unique, identifiable, pattern over an interval of time, thereby allowing a variety of gesture movements, each with a unique repeatable pattern of movement. For example, a handshake is a specific “up and down” motion over a short period of time. Similarly, a fist bump is a forward motion with an abrupt stop over a short period of time. In an exemplary embodiment sensor(s) 124 may transmit an entire movement to wearable program 122, as a function of time.

Additionally, sensor(s) 124 may detect instantaneous motion. A gesture may encompass a specific movement given at an instant in time. For example, a specific movement, or orientation. Through one or more instantaneous motions detected by sensor(s) 124, wearable program 122 may derive the intended gesture, and commence the predetermined data transfer.

Database 126 may include any suitable volatile or non-volatile computer readable storage media, and may include random access memory (RAM) and cache memory (not depicted in FIG. 1). Wearable program 122 may be stored in a persistent storage component (not depicted) for execution and/or access by one or more of processor(s) via one or more memories (for more detail refer to FIG. 3). Alternatively, or in addition to a magnetic hard disk drive, the persistent storage component can include a solid state hard drive, a semiconductor storage device, read-only memory (ROM), erasable programmable read-only memory (EPROM), flash memory, or any other computer readable storage media that is capable of storing program instructions or digital information.

Database 126 stores actual, modeled, predicted, or otherwise derived patterns of movement based on sensor data. For example, database 126 may contain lookup tables, databases, charts, graphs, functions, equations, and the like that wearable program 122 may access to both determine a specific gesture as well as transmit specific data to computing device 130. Information stored in database 126 may include: various gestures or movements, specific actions linked to the various gestures, dictating what data should be transmitted, as well as the data itself. While depicted on wearable device 120, in the exemplary embodiment, database 126 may be on a remote server or a “cloud” of computers interconnected by one or more networks utilizing clustered computers and components to act as a single pool of seamless resources, accessible to wearable program 122 via PAN 110.

Computing device 130 of user interface environment 100 is to be interpreted broadly. Exemplary embodiments of computing device 130 includes, but not limited to a ring, a bracelet, a watch, a smart phone, a tablet, a laptop, a netbooks, handheld computers, personal organizers, e-reading devices, gaming devices or a computer.

Computing device 130 may include a database 136, as well as additional components not shown. In an exemplary embodiment, computing device 130 may be identical to that of wearable device 120, regarding its internal components. For example, computing device 130 may contain components similar to wearable device 120, including wearable program 122, and sensor(s) 124. Thereby, computing device 130, may also detect and transmit data to wearable device 120. For instance, computing device 130 may transmit similar data back to wearable device 120, in response to receiving data. For example, if wearable device 120 transmits a virtual business card to computing device 130, then computing device 130 may in return send to wearable device 120 virtual business of its user. In another embodiment, computing device 130 may transmit data to wearable device 120, in response to detecting a gesture by a user. Additionally, computing device 130 may only receive data, and not send data. Alternatively, computing device 130 may not be similar to that of wearable device, to the extent that computing device 130 may only receive information, not transmit information or detect gestures or movements.

In some embodiments, computing device 130 may leverage other devices external to the wearable device, such as a mobile phone or a personal computer. The concepts disclosed and discussed herein, may be applied to both, a standalone wearable device, as well as a wearable device that leverages functionalities provided in external devices, e.g., smartphones, wireless headphones, etc.

Database 136 may include any suitable volatile or non-volatile computer readable storage media, and may include random access memory (RAM) and cache memory (not depicted in FIG. 1). Alternatively, or in addition to a magnetic hard disk drive, the persistent storage component can include a solid state hard drive, a semiconductor storage device, read-only memory (ROM), erasable programmable read-only memory (EPROM), flash memory, or any other computer readable storage media that is capable of storing program instructions or digital information. While depicted on computing device 130, in the exemplary embodiment, database 136 may be on a remote server or a “cloud” of computers interconnected by one or more networks utilizing clustered computers and components to act as a single pool of seamless resources, via a network connection to the internet (not shown).

Database 136 may store data received from wearable device 120. Additionally, database 136 may contain information to send to wearable device 120. For example, computing device 130, upon receipt of data, may reciprocate similar data to wearable device 120. In an alternative embodiment, upon receipt of data, computing device 130 may transmit unrelated data to wearable device 120. In another embodiment, upon detection of a gesture, computing device 130 may transmit specific data, related to the gesture, to wearable device 120.

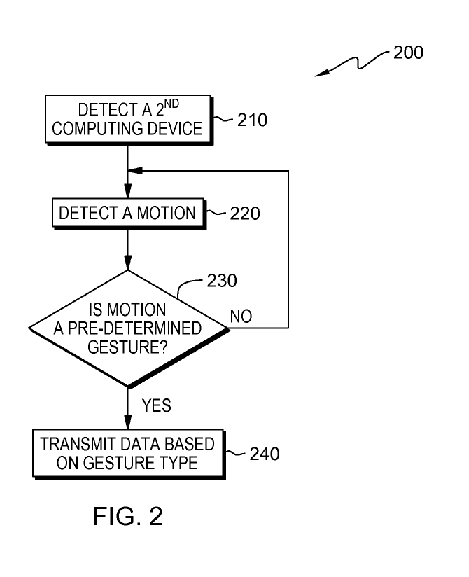

Reference is now made to FIG. 2. FIG. 2 is flowchart 200 depicting operational steps of wearable program 122 for detecting and transmitting data from wearable device 120 to computing device 130, in accordance with an embodiment of the present invention. It should be noted that data can be transmitted in the reverse direction as well, for example from computing device 130 to wearable device 120.

In step 210 wearable program 122 detects and gathers information about the presence and relative location of nearby computing device 130. Wearable device 120 includes one or more components to detect computing device 130. For example, wearable program 122 utilizing known techniques in the art, including, radio waves, acoustics, and/or optics, detects computing device 130. In an exemplary embodiment, wearable device 120 may include a Near Field Communication Chip (NFC), to detect nearby devices. In an exemplary embodiment, wearable device 120 may include a Bluetooth communication to detect nearby devices. In an exemplary embodiment, wearable device 120 may emit an inaudible sound wave or light waves to detect computing device 130.

In one exemplary scenario, wearable program 122 is continually searching for nearby devices. In an alternative exemplary scenario, upon wearable program 122 determining that no computing devices 130 and/or movement is detected, after a certain period of time, wearable program 122 enters a hibernating state, minimizing power usage and routinely checking sensor(s) 124 for movement and/or components to detect computing device 130.

In step 220, wearable program 122 receives an indication of a motion. Upon detecting computing device 130, wearable program 122 continually monitors for motions via sensor(s) 124. In an exemplary embodiment, sensor(s) 124 is used to identify various types of motion. Sensor(s) 124 may be capable of detecting a variety of motions, including, but not limited to, at least one axis of movement, a frequency of movement, and a force of movement. For example, sensor 124 may detect movement along one or more axis of wearable device 120. In another example, sensor 124 may in addition to or alternatively, detect and/or calculate a movement's frequency, such as vibrations, or repeated movements of wearable device 120. In another example, sensor(s) 124 may also be capable of detecting a movement's force, the for instance, the magnitude, acceleration and/or G-Force of a movement applied to wearable device 120. In an alternative embodiments sensor(s) 124 may additionally or alternatively detect variations in pressure, temperature, and/or light as well as other measurable characteristics known in the art.

For example, a handshake motion, might be detected by a strong repetitive upward and downward motion. Whereas a ‘fist bump’ or ‘high five’ motion might be detected by a forward acceleration followed by a sudden stop.

In an alternative embodiment, step 210 and step 220 may be reversed, to the extent that, wearable device 120 first detects motion from one or more of its sensor(s) 124 and then commences detecting for computing device 130. Upon wearable program 122 determining that the motion is a predetermined gesture as well as detecting computing device 130, wearable program 122 may then perform the operations of step 240. Wearable program 122 may first search and detect computing device 130 prior to determining if the motion detected is a predetermined gesture. Alternatively, wearable program 122 may first determine if the motion detected is a predetermined gesture prior to searching for computing device 130. Under these alternative embodiments, wearable device 120 is not actively searching for computing device 130; rather it is passively waiting to receive an indication of a motion.

In step 230, wearable program 122 determines if the received information from sensor(s) 124, are a predetermined gesture, or a generic movement of the user of wearable device 120. The user of wearable device 120 may pre-program any repeatable gesture as a gesture profile. Database 126 may contain one or more profiles of gestures, to which wearable program 122 compares motions. Wearable program 122 utilizing some or all of sensors(s) 124 determines if the movement is a predetermined gesture, each with a unique repeatable pattern of movement. Wearable program 122 compares the received motions (including instantaneous as well as a function of time) to one or more known, predesignated gestures. Wearable program 122 may continuously compare motions patterns to that of the one or more predetermined gesture until a predetermined gesture is recognized.

For example, the type of gesture used may dictate a familiarity level the user of wearable device 120 has with the user of computing device 130. For example, a handshake being the most formal to a less formal fist bump.

If, in step 230, wearable program 122 determines that a motion is a pre-determined gesture, then, in step 240, wearable program 122 transmits data, pertaining to the detected gesture, to computing device 130. Database 126 may contain a gesture profile, containing one or more types of information wearable program 122 is to transfer via PAN 110 to computing device 130. For example, gesture profile number 1, might pertain to a handshake gesture and upon recognition transfer a virtual business card. Similarly, gesture profile number 2 may pertain to a ‘fist bump’ as the received/pre-determined gesture, and upon recognition, transfer a play list. Whereas gesture profile number 3 may pertain to a ‘high-five’ as the pre-determined gesture, and upon recognition, transfer an electronic document. It is understood that any number of predetermined gestures can be established by a user as well as the data transferred correlating to each predetermined gesture.

In one exemplary embodiment, wearable program 122, may send a data package to computing device 130, upon detection of a predetermined gesture. The data package may also contain a PGP key. Computing device 130, upon receipt of the data package, may do nothing, thereby ending the transfer of data. Alternatively, computing device 130, upon receipt of the data package, may reciprocate with similar data. For example, if wearable program 122 transmits a virtual business card of a user, computing device 130, may reciprocate and transfer a virtual business card of its user.

In an alternative exemplary embodiment, in order for data to be transferred between wearable device 120 and computing device 130, both devices must make the same gesture. For example, both devices interact in a simultaneous handshake, ‘high-five’, ‘fist-bump’, etc. Upon the same gesture occurring between the two devices, the devices may pair, and transfer a data package at a similar time.

In an exemplary embodiment, wearable program 122 may learn new gestures and store the new gestures, in addition to recognizing previously stored gestures. Additional gesture profiles may be created in a training mode where wearable program 122 learns specific gestures or motions of the user of wearable device 120. During a gesture recognition training process, wearable program 122 may require the user to preform multiple successive repetitions of a training gesture. It will be apparent to those skilled in the art that any number of repetitions of the training gesture may be employed during the training process. Wearable program 122 may store the gesture in the gesture profile of database 126. Accordingly, after wearable program 122 learns a new gesture, or pattern of movement, a user of wearable device 120 may associate specific data to be shared to computing device 130 upon a detection of the gesture. Subsequently, upon wearable program 122 detecting a second computing device (see step 210) and upon recognition by wearable program 122 of a gesture by sensor 124 (see step 220), wearable program 122 may continue with the operational steps of flowchart 200.

If, in step 230, wearable program 122 determines that a motion is not a pre-determined gesture, then wearable program 122 does not move to step 240 as no action is taken nor is any data transferred.

In an alternative embodiment, wearable program 122 may contain one or more classes of gestures. For example, gestures categories may include social and/or business, each of which may transmit different files. In one scenario, if in step 230 wearable program 122 determines that the gesture is within a business class gesture (for example a handshake), then in step 240 wearable program 122 may transmit to computing device 130 a professional class of information (for example a electronic business card). Alternatively, if, in step 230 wearable program 122 determines that the gesture is within a social class gesture (for example a fist bump), then in step 240 wearable program 122 may transmit to computing device 130 socially appropriate information (for example a social media request, general contact information, a playlist, etc.).

FIG. 3 is a block diagram of internal and external components of a computer system 300, which is representative of, wearable device 120 and/or computing device 130 of FIG. 1, in accordance with an embodiment of the present invention. It should be appreciated that FIG. 3 provides only an illustration of one implementation and does not imply any limitations with regard to the environments in which different embodiments may be implemented. In general, the components illustrated in FIG. 3 are representative of any electronic device capable of executing machine-readable program instructions. Examples of computer systems, environments, and/or configurations that may be represented by the components illustrated in FIG. 3 include, but are not limited to, personal computer systems, server computer systems, thin clients, thick clients, laptop computer systems, wearable computing devices, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 300 includes communications fabric 302, which provides for communications between one or more processors 304, memory 306, persistent storage 308, communications unit 312, and one or more input/output (I/O) interfaces 314. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 316 and cache memory 318. In general, memory 306 can include any suitable volatile or non-volatile computer readable storage media. Software (e.g., wearable program 122) is stored in persistent storage 308 for execution and/or access by one or more of the respective processors 304 via one or more memories of memory 306.

Persistent storage 308 may include, for example, a plurality of magnetic hard disk drives. Alternatively, or in addition to magnetic hard disk drives, persistent storage 308 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 308 can also be removable. For example, a removable hard drive can be used for persistent storage 308. Other examples include optical and magnetic disks, thumb drives, and smart cards that are inserted into a drive for transfer onto another computer readable storage medium that is also part of persistent storage 308.

Communications unit 312 provides for communications with other computer systems or devices via a network (e.g., network). In this exemplary embodiment, communications unit 312 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to through communications unit 312 (e.g., via the Internet, a local area network or other wide area network). From communications unit 312, the software and data can be loaded onto persistent storage 308.

One or more I/O interfaces 314 allow for input and output of data with other devices that may be connected to computer system 300. For example, I/O interface 314 can provide a connection to one or more external devices 320 such as a keyboard, computer mouse, touch screen, virtual keyboard, touch pad, pointing device, or other human interface devices. External devices 320 can also include portable computer readable storage media such as, for example, thumb drives, portable optical or magnetic disks, and memory cards. I/O interface 314 also connects to display 322.

Display 322 provides a mechanism to display data to a user and can be, for example, a computer monitor. Display 322 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for sharing content between devices, the method comprising:
storing, by one or more processors, a first gesture, wherein the stored first gesture comprises movement data and an associated first data file;
discovering, by a first device, a second device, wherein the first device is a wearable computing device, configured to detect movement and send the associated first data file wirelessly to the second device, and wherein the second device is a computing device;
receiving, by one or more processors, at least one movement of the first device;
determining, by one or more processors, that the received at least one movement of the first device is similar to the stored first gesture; and
in response to determining the received at least one movement of the first device is similar to the stored first gesture, sending the associated first data file from the first device to the second device.

2. The method of claim 1, further comprising:
responsive to sending the associated first data file from the first device to the second device, receiving by the first device, a second data file from the second device.

3. The method of claim 1, wherein the second device is a wearable device.

4. The method of claim 1, wherein receiving the at least one movement of the first device comprises:
detecting a set of movement data from the first device, wherein the set of movement data comprises at least one of: an axis of movement data; a frequency of movement data; and a force of movement data.

5. The method of claim 1, further comprising:
storing, by one or more processors, a second gesture, wherein the stored second gesture comprises movement data and an associated second data file;
discovering, by the first device, the second device, wherein the first device is configured to detect movement and send the associated second data file wirelessly to the second device;
receiving, by one or more processors, at least one movement of the first device;
determining, by one or more processors, that the received at least one movement of the first device is similar to the stored second gesture; and
in response to determining the received at least one movement of the first device is similar to the stored second gesture, sending the associated second data file from the first device to the second device.

6. The method of claim 1, wherein a handshake gesture indicates a business class transaction and an associated data file is an electronic business card.

7. The method of claim 1, wherein a fist bump gesture indicates a social class transaction and an associated data file is social media account information.

8. The method of claim 1, wherein a formality level of the received at least one movement of the first device indicates a similar formality level of an associated data file sent from the first device to the second device.
